(19) United States
(12) Patent Application Publication
(10) Pub. No.: US 2010/0112943 A1
(43) Pub. Date: May 6, 2010

(54) RECEIVER ARRANGEMENT AND A TRANSMITTER ARRANGEMENT

(75) Inventors: Michael Yan Wah Chia, Singapore (SG); Karen Chai Moy Ang, Singapore (SG)

Correspondence Address: CHOATE, HALL & STEWART LLP, TWO INTERNATIONAL PLACE, BOSTON, MA, 02110, US

(73) Assignee: AGENCY FOR SCIENCE, TECHNOLOGY AND RESEARCH, Centros (SG)

(21) Appl. No.: 12/161,442

(22) PCT Filed: Jan. 24, 2007
(86) PCT No.: PCT/IB2007/000164

§ 371 Date: Jan. 19, 2010

Related U.S. Application Data
(60) Provisional application No. 60/761,457, filed on Jan. 24, 2006.

(51) Int. Cl. H04B 7/005; G08B 13/14

(52) U.S. Cl. 455/41.2; 340/572.1

(57) ABSTRACT

A transmitter/receiver (a transceiver) having: a digital synthesizer signal generator (101) to generate multiple references signals from a reference clock signal (111), a plurality of transmitters/receivers (103) where each generating corresponding reference signal from the transmitter/receiver reference signals, an up/down convert the transmit/receive signal using the corresponding reference-signal, wherein a plurality of antennas (105) coupled to the at least one transmitter/receiver of the plurality of transmitters/receivers (103).

The present application claims the benefit of U.S. provisional application 60/761,457 (filed on 24 Jan., 2006), the entire contents of which are incorporated herein by reference for all purposes.

### BACKGROUND

The present invention refers to a receiver arrangement and a transmitter arrangement.

It is common to use antennas in wireless communication technologies. Usually the use of multiple antennas provides diversity and hence better performance. However, this performance improvement is usually achieved at the expense of implementation complexity.

In the design of a typical system using multiple antennas, each time when multiple antennas are adapted for beam steering, a considerable redesign effort is usually required at the baseband interface to the antennas. Accordingly, a number of approaches have been developed to adapt multiple antennas for beam steering without having to spend considerable effort to redesign the baseband interface to the antennas. Some of these approaches are described as follows.

Near-field focused phased array and scanning antennas for radio frequency identification (RFID) applications have been demonstrated. In addition, the use of electronic tunable radio frequency (RF) components for developing smart antennas for beam-steering in RFID, is conventional.

Furthermore, an electronic beam steering of active arrays using phase-locked loops (PLL) has conventionally been used. Each antenna may be controlled by a PLL and each PLL may receive an offset voltage. The offset voltage is adjusted to control the phase difference in the signal generated by each PLL, thus controlling the beam direction. An embodiment of the invention is able to provide over 100° of adjustable phase difference between adjacent oscillators.

However, it can be seen that the range of angles within which the beam can be steered is limited.

Further, a conventional electronically scanned phased array antenna system and method with scan control independent of radiating frequency use mixers and a phase delay network (based on time delay lines), which is driven by a frequency synthesizer, to generate a phased array signal.

In this regard, the amount of relative phase difference between the phased array signals is subject to the physical limitations of the phase delay network used. Accordingly, it is not possible to achieve the small values of relative phase difference between the phased array signals needed to obtain fine control of steering the radiation beam of the phased array antenna system.

In another conventional beam-forming system, all the components of the system including the antenna circuits are integrated on silicon. This system has a controller which provides phasing information to the oscillators.

In an alternative embodiment of this system, the phasing information is controlled through a fixed corporate feed network. The relative gain of the antenna signals received or transmitted through the fixed corporate feed network is adjusted accordingly to provide beam steering.

However, in this case, it is also not possible to achieve the small values of relative phase difference between the phase delayed antenna signals needed to obtain fine control of beam steering. In addition, it can be seen that the addition of a new feature to the system will require a redesign of the integrated circuit chip.

Accordingly, it can be seen that each of the above mentioned approaches to solve the problem of adapting multiple antennas for beam steering without a considerable redesign effort is required at the baseband interface to the antennas, has some inherent disadvantages.

Therefore, there is a need of the present invention, which will be described in more detail below.

### SUMMARY OF THE INVENTION

In an embodiment of the invention, a receiver arrangement is provided, including a digital synthesizer signal generator. The digital synthesizer signal generator has an input receiving a reference clock signal, a plurality of outputs, each output providing a reference signal being derived from the reference clock signal, wherein the plurality of reference signals have substantially the same frequency and different phases. Furthermore, a plurality of receivers is provided, each receiver including a reference signal input receiving one reference signal of the plurality of reference signals, a receiver reference signal generator generating a receiver reference signal using the received reference signal, an antenna input receiving a transmission signal, and a downconverting circuit downconverting the received transmission signal using the receiver reference signal. Further, a plurality of antennas is provided coupled to the antenna input of at least one receiver of the plurality of receivers.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a block diagram of a communication system using a plurality of antennas, according to an embodiment of the invention.

FIG. 2 shows a block diagram of the digital synthesizer signal generator according to an embodiment of the invention.

FIG. 3 shows an embodiment of the invention, wherein the number of transceivers is the same as the number of antennas.

FIG. 4 shows a block diagram of a communication system using a plurality of antennas, according to an embodiment of the invention.

FIG. 5 shows an arrangement of the plurality of antennas for use in determining the distance of a communication device transmitting signals to the system, according to an embodiment of the invention.

FIG. 6 shows an arrangement of the plurality of antennas using a set of radio frequency (RF) switches to switch between antennas for elevation and azimuth scanning, according to an embodiment of the invention.

FIG. 7 shows a block diagram of the feedback network of the communication system using a plurality of antennas, according to an embodiment of the invention.

FIG. 8 shows a block diagram of the transmit signal path of the communication system using a plurality of antennas, according to an embodiment of the invention.

FIG. 9 shows a block diagram of the receive signal path of the communication system using a plurality of antennas, according to an embodiment of the invention.

FIG. 10 shows the effects of vector combining at the combiner of the communication system using a plurality of antennas, according to an embodiment of the invention.

FIG. 11 shows a block diagram of a communication system using a plurality of antennas with a frequency compensation circuit, according to an embodiment of the invention.

FIG. 12 shows an illustration of how signal recombination is used to reduce the number of transceivers, according to an embodiment of the invention.

FIG. 13 shows the antenna radiation patterns for the communication system using a plurality of antennas, when time delays of 0 ps and 100 ps respectively are used, according to an embodiment of the invention.

### DESCRIPTION

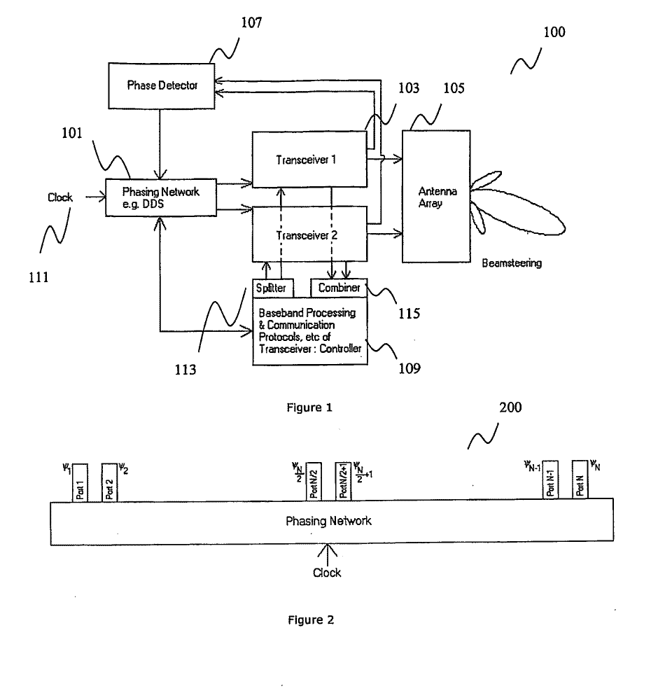

FIG. 1 shows a block diagram of a communication system 100 using a plurality of antennas, according to an embodiment of the invention.

The communication system 100 includes a digital synthesizer signal generator 101 (denoted as Phasing Network), a plurality of transceivers 103, a plurality of antennas 105 (denoted as Antenna Array), a phase detector circuit 107 and a baseband processing and communication unit 109.

The digital synthesizer signal generator 101 provides a plurality of reference signals, which have substantially the same frequency and different phases. Each reference signal is derived from the reference clock signal 111 (denoted as Clock). According to one embodiment of the invention, the reference clock signal is a crystal clock signal.

Additionally, in one embodiment of the invention, each reference signal is a phase delayed version of the reference clock signal 111. This means that the plurality of reference signals have substantially the same frequency but different phases.

For example, the digital synthesizer signal generator 101 may be, but is not limited to, at least one Direct Digital Synthesizer (DDS).

Each transceiver of the plurality of transceivers 103 has a reference signal generator. The reference signal generator converts a low frequency clock signal to a high frequency radio signal in such a manner that the high frequency radio signal is synchronous to the low frequency clock signal.

The reference signal generator has a frequency synthesizer. The frequency synthesizer may be, but is not limited to, a phase-locked loop (PLL) based frequency synthesizer or a delay-locked loop (PLL) based frequency synthesizer, for example.

In this regard, the reference signal generator in the transmitter arrangement is called the transmitter reference signal generator, while the reference signal generator in the receiver arrangement is called the receiver reference signal generator.

Each transceiver of the plurality of transceivers 103 further includes other components required to design a general transceiver such as an amplifier, an attenuator, a mixer, a modulator, a demodulator, a filter, a coupler, a microcontroller and a comparator, for example.

Each transceiver of the plurality of transceivers 103 may be, but is not limited to, a radio frequency identification (RFID) interrogator, for example.

The phase detector circuit 107 provides phase compensation information, which is used to perform phase compensation for the transmit reference signals of the transmitter arrangement, according to an embodiment of the invention. The transmit reference signals are the high frequency carrier signals used for modulating or upconverting a baseband transmit data signal.

The baseband processing and communication unit 109 performs a number of functions, for example, provides processed data to be transmitted to the at least one transceiver 103, provides further processing for data received from the at least one transceiver, provides services and interfaces in order to communicate with other devices, and provides control signals to the other components in the communication system 100.

With regard to providing control signals to the other components in the communication system 100, the baseband processing and communication unit 109 includes at least one digital controller for digitally controlling the digital synthesizer signal generator 101.

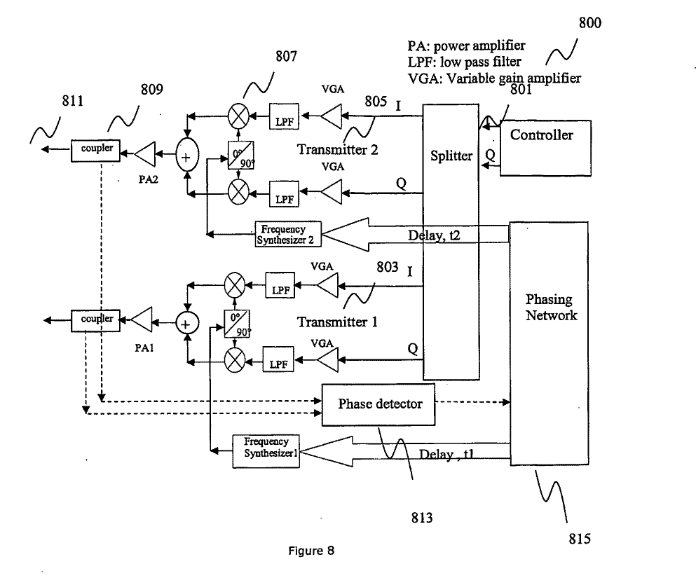

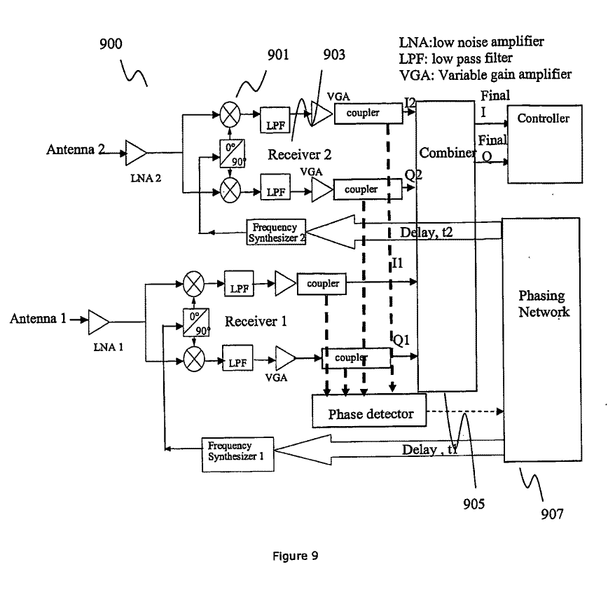

The baseband processing and communication unit 109 further comprises a splitter 113 and a combiner 115. The functions of the splitter 113 and the combiner 115 will be discussed in detail in relation to FIGS. 8 and 9 respectively.

FIG. 2 shows a block diagram of the digital synthesizer signal generator 200 according to an embodiment of the invention.

In this example of the digital synthesizer signal generator 200, the digital synthesizer signal generator 200 includes a plurality of output ports. Each output port provides a reference signal, which is a low frequency clock signal.

In this embodiment, the relative phase difference between the reference signals at two adjacent output ports is substantially equal. In other words, as shown in FIG. 2, the relative phase difference sψ between any two adjacent output ports of the digital synthesizer signal generator is given by

Δψ=ψ₂−ψ₁=ψ₃−ψ₂= . . . =ψ_{N}−ψ_{N-1} (1)

Additionally, it should be noted that there exists a range of values within which Δψ can be changed.

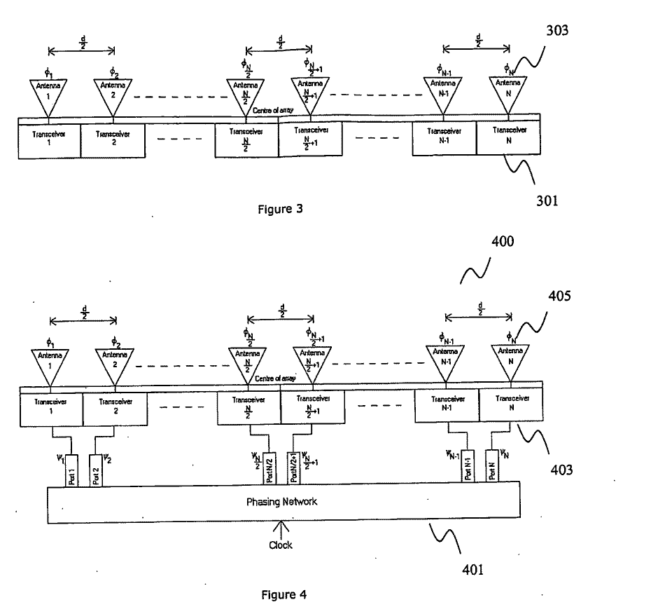

FIG. 3 shows an embodiment of the invention, wherein the number of transceivers is the same as the number of antennas.

In this embodiment, N transceivers are coupled to N antennas, and each transceiver 301 is coupled to an antenna 303.

The antennas are arranged such that the distance between each of the adjacent antennas is the same (d/2).

For the transmitter arrangement, the antenna-transceiver array, as shown in FIG. 3, is assembled such that the phase delay of the radio frequency signal transmitted by each antenna is different. Additionally, the relative phase difference Δφ of the radio frequency signals transmitted by two adjacent antennas is the same so that

Δφ=φ₂φ₁=φ₃−φ₂= . . . =φ_{N}−φ_{N-1} (2)

When Δφ is zero, the phase delay of the radio frequency signal transmitted by each antenna is the same for all antennas.

FIG. 4 shows a block diagram of a communication system 400 using a plurality of antennas according to an embodiment of the invention.

The digital synthesizer signal generator 401 is connected to the plurality of transceivers 403 and provides a plurality of (low frequency) reference signals to the plurality of transceivers 403.

For the transmitter arrangement, the relative phase difference Δψ between the reference signals at adjacent output ports of the digital synthesizer signal generator 401 and the relative phase difference Δφ between the (high frequency) transmitter reference signals corresponding to the transmitter (of the transceiver 403) connected to the adjacent output ports of the digital synthesizer signal generator 401 are related by

$$Δ φ = \frac{Δ ψ \times {f}_{RF}}{{f}_{CLK}} \qquad ( 3 )$$

where f_{RF} and f_{CLK} are the frequencies of the high frequency transmitter reference signal and the low frequency reference signal respectively.

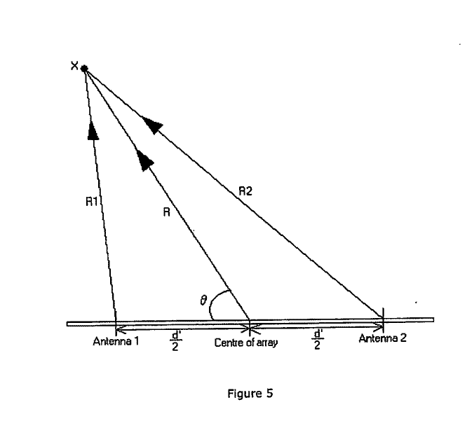

FIG. 5 shows an arrangement of the plurality of antennas for use in determining the distance of a communication device transmitting signals to the system, according to an embodiment of the invention.

In this embodiment, the number of antennas in the plurality of antennas, N=2, as shown in FIG. 5. Here, the antennas are assumed to be infinitesimal dipoles.

From FIG. 5, the position of a communication device X can be determined if both R and θ are known.

As a side remark, the total electric field at any point is the sum of the two individual electric fields produced by the two antennas. The total electric field is stronger where the two individual electric fields interfere constructively. On the other hand, the total electric field is weaker where the two individual electric fields interfere destructively. In electronic beam-steering, the relative phase difference between the transmitted signals on the antennas results in some direction where the total electric field is the strongest. By varying the relative phase difference between the transmitted signals on the antennas, the direction of strongest electric field can be varied. Accordingly, the radiation beam of the antennas can be steered.

In FIG. 5, the angle θ can be determined by varying the relative phase difference Δφ of the signals transmitted by the two antennas, to search for the direction where the sum of the power of the signals received by the two transceivers coupled to the said two antennas, is maximum. Based on the power of the signal received by each transceiver, the distance R1 and R2 can be estimated and the distance R can be calculated by

R=0.5(R1²+R2²+d²) (4)

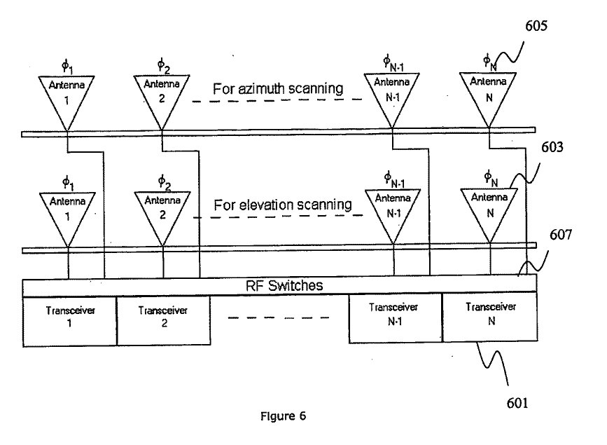

FIG. 6 shows an arrangement of the plurality of antennas using a set of radio frequency (RF) switches to switch between antennas for elevation and azimuth scanning, according to an embodiment of the invention.

The communication system according to an embodiment of the invention, as shown in FIG. 1 for example, is able to perform beam-steering in either the elevation plane or the azimuth plane. An additional array of antennas is provided in order to perform beam-steering in both planes.

In another embodiment of the invention, two arrays of N antennas and an array of N transceivers 601 are arranged, as shown in FIG. 6. The first array of N antennas 603 is designated for beam-steering in the elevation plane while the second array of N antennas 605 is designated for beam-steering in the azimuth plane. A set of N switches 607 is also included in the system, and is used to connect the array of N transceivers to one of the antenna arrays, as shown in FIG. 6.

It is possible to achieve cost savings as well as power consumption reduction by switching the connection from the array of transceivers to one of the two antenna arrays.

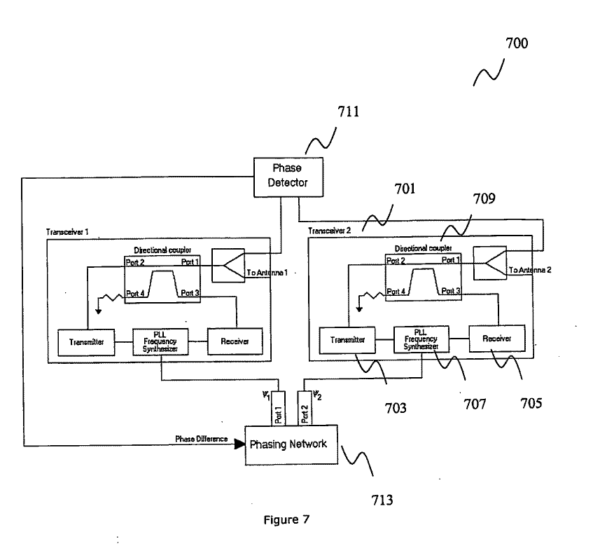

FIG. 7 shows a block diagram of the feedback network 700 of the communication system using a plurality of antennas, according to an embodiment of the invention.

The inherent differences between different transceivers in the communication system result in errors in the relative phase difference of the transmitted radio frequency signals. Two overcome this problem, a feedback network can be implemented to measure and compensate for these errors. An example of the communication system with the number of antennas in the plurality of antennas (N=2) with a feedback network incorporated, is shown in FIG. 7.

Each transceiver 701 includes of a transmitter 703, a receiver 705, a phase-locked loop (PLL) frequency synthesizer 707 and a circulator (or directional coupler) 709. The circulator or directional coupler allows a single antenna to be shared between the transmitter and the receiver.

The phase detector circuit 711 compares the phases of the transmitter reference signals and sends a signal indicating the relative phase difference to the digital synthesizer signal generator 713, which will then tune the relative phase difference of the corresponding low frequency reference signals, to compensate for the errors due to the different transceivers. Effectively, the phase detector circuit 711 provides the feedback path in the said feedback network.

As a side remark, a signal leakage occurs from the transmit signal path into the receive signal path in the circulator or directional coupler 709 in each transceiver in FIG. 7. The relative phase difference between the leakage signals in different transceivers can be similarly measured using a phase detector circuit 711. Hence, the phase error at the receivers can be calculated by subtracting the relative phase difference between the transmitter reference signals from the relative phase difference between the leakage signals in different transceivers.

FIG. 8 shows a block diagram of the transmit signal path of the communication system 800 using a plurality of antennas, according to an embodiment of the invention.

In FIG. 8, the transmit signal data is separated into two parts at the Splitter 801, one part to be transmitted by Transmitter 1 803 and the other part to be, transmitted by Transmitter 2 805.

The transmit data signal at Transmitter 2 805 is upconverted at the pair of mixers 807. The directional coupler 809 (or power splitter) splits the upconverted transmitted signal into two, so that one signal is coupled to the antenna 811 while the other signal is coupled to a phase detector 813.

As explained earlier, the phase difference between adjacent upconverted transmitted signals are fed back to the digital synthesizer signal generator 815 (denoted by Phasing Network), to provide phase compensation.

FIG. 9 shows a block diagram of the receive signal path of the communication system 900 using a plurality of antennas, according to an embodiment of the invention.

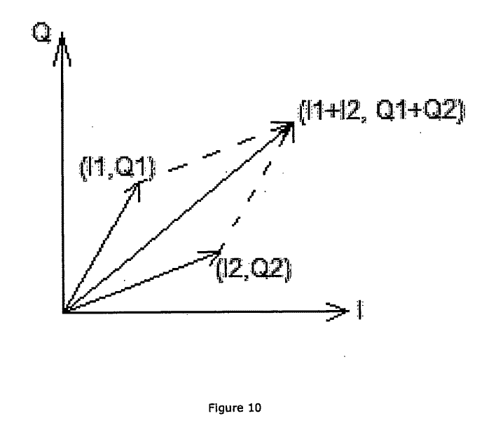

In FIG. 9, the receive signal is downconverted at the pair of mixers 901 of Receiver 2 903. The pair of downconverted base-band signals (in-phase (I) and quadrature (Q)) is filtered and combined at Combiner 905, to provide the strongest signal (Final (I+jQ), as shown in Equation (5)) so as to achieve a higher Signal to Noise Ratio (SNR) for the received signal as compared to a single receiver, as shown in FIG. 10.

Final(I+jQ)=(I1+I2)+j(Q1+Q2) (5)

In this embodiment of the invention, multiple local oscillator signals will be phased controlled by delays, t1 and t2, for example, by the digital synthesizer signal generator 907.

It should be noted that the higher SNR achieved allows the plurality of antennas to receive signals from a communication device, which may be located further away from the plurality of antennas.

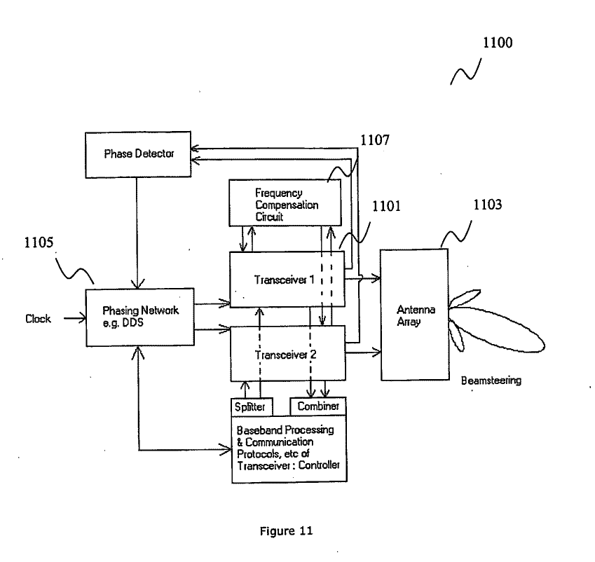

FIG. 11 shows a block diagram of a communication system 1100 using a plurality of antennas with a frequency compensation circuit, according to an embodiment of the invention.

There are many causes of frequency deviations in communication system 1100. Frequency deviations are inherent in different frequency synthesizers in the different transceivers 1101.

Also, mutual coupling between adjacent antennas of the plurality of antennas 1103 (denoted as Antenna Array) will result in the coupling of the transmitter reference signal from one transceiver to another. As a result, low frequency noise appears at the downconverter of the receiver of each transceiver due to the frequency deviations, which affects the performances of the receiver.

The frequency deviations in different synthesizers can be compensated by setting the digital synthesizer signal generator 1105 (denoted as Phasing network) to generate low frequency clock signals with frequency deviations.

Alternatively, the frequency deviations in the different frequency synthesizers can be compensated by implementing a frequency compensation circuit 1107 in the system, as shown in FIG. 11. The frequency compensation circuit, for example, may comprise of couplers (or splitters) to couple a small local oscillator (LO) signal from each transceiver and use mixers at the receivers to compensate the frequency deviation in the local oscillators.

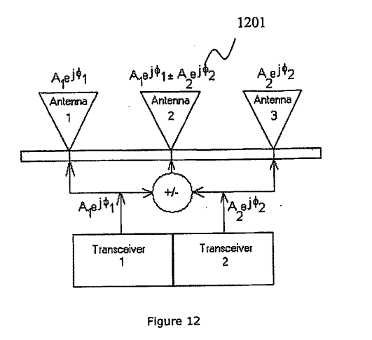

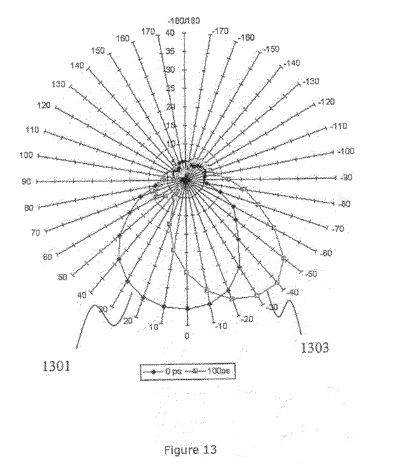

FIG. 12 shows an illustration of how signal recombination is used to reduce the number of transceivers, according to an embodiment of the invention.

The number of transceivers in the system can be reduced by combining the signals of a few transceivers and feeding the combined signal to another antenna in the array. In the illustration shown in FIG. 12, 2 transceivers are coupled to 3 antennas. The signal transmitted by Antenna 2 1201 is given by

S2=A₁e^{jφ1}±A₂e^{jφ2} (6)

FIG. 13 shows the antenna radiation patterns for the communication system using a plurality of antennas, when time delays of 0 ps and 100 ps respectively are used, according to an embodiment of the invention.

The antenna radiation patterns with time delay of 0 picoseconds (ps) (1301) and at 100 ps (1303) respectively, as shown in FIG. 13, are obtained using the following parameters.

Frequency of transmission=˜924 MHz
Number of antennas=2 directional dipole with metal reflector.
Separation between 2 antennas=10 cm

It can be observed that the antenna radiation pattern with time delay of 100 ps (1303) has been tilted by 30° with reference to the bore-sight (0°) of the antenna radiation pattern with time delay of 0 ps (1301).

Additionally, the Effective Isotropic Radiated Power (EIRP) of a transceiver is required to meet the signal transmission regulations set by the relevant authorities. The EIRP of each of the antenna-transceiver array is less than or equal to the EIRP defined in the standard signal transmission regulations divided by N. As a result, the power requirement for each transceiver is lowered, and accordingly, a power amplifier of lower power can be used.

Also, the lower power requirement will extend the operational lifetime of a communication system. Other advantages obtained from using a power amplifier of lower power include lower current consumption, lower heat dissipation and lower cost. In addition, the gain of each antenna can be reduced such that the size of the array of antennas is the same as that of a single antenna for the original EIRP.

In one embodiment, the reference clock signal is a crystal clock signal.

In an embodiment of the invention, the digital synthesizer signal generator may provide a plurality of reference signals, wherein each reference signal is a phase delayed version of the crystal clock signal. In order to obtain very small values of phase delays in the phase delayed signals, especially for high frequency applications, the clock signal must have very low phase noise. For this reason, a crystal oscillator may be used to directly provide the clock signal, because the clock signal from a crystal oscillator has very low phase noise.

Additionally, the crystal clock signal may be obtained directly from a crystal oscillator. This means that the clock signal is not processed by any additional circuitry, such as a phase-locked loop (PLL), for example. This is done to ensure that the crystal clock signal has as little phase noise as possible, since additional circuitry may introduce phase noise to the crystal clock signal.

In view of the above, when very small values for phase delays in the phase delayed signals are obtained, this allows fine control of the beam steering of the receiver arrangement provided in accordance with an embodiment of the invention.

In one embodiment, the digital synthesizer signal generator includes at least one Direct Digital Synthesizer (DDS).

As used herein, a Direct Digital Synthesizer (DDS) may be understood as being an electronic device which accepts a signal with a reference frequency (typically a clock signal), and which generates and outputs at least one signal of a frequency determined by an input control word or method. In particular, in an embodiment of the invention, the Direct Digital Synthesizer (DDS) employs the technique of direct digital synthesis.

The output signal generated by the direct digital synthesis technique may be synthesized based on a digital definition of the desired result. In this regard, logic and memory may be used to digitally construct the desired output signal, and subsequently, a data conversion device to convert it from the digital domain to the analog domain. Therefore, in an embodiment of the invention, the direct digital synthesis technique of constructing a signal is almost entirely digital, wherein the precise amplitude, frequency, and phase of the signal are known and controlled at all times.

In this regard, the direct digital synthesis technique can be implemented using different arrangements of logic and memory devices. Accordingly, in one embodiment, the digital synthesizer signal generator comprises a programmable processor. In another embodiment, the digital synthesizer signal generator comprises a (programmable) microprocessor.

Additionally, in an embodiment of the invention, another feature of the direct digital synthesis technique is that it is possible to achieve low phase noise in the output signal, roughly equal to the phase noise of its input reference clock signal. Accordingly, the use of the direct digital synthesis technique (or the Direct Digital Synthesizer (DDS)) in conjunction with a clock signal with low phase noise allows very small values of phase delays in the phase delayed signals to be obtained, thereby allowing fine control of the beam steering of the receiver arrangement provided in accordance with an embodiment of the invention.

In one embodiment, the plurality of antennas is arranged in a manner such that the distance between each of adjacent antennas is substantially equal.

In one embodiment, the receiver arrangement provided includes a communication device transmitting signals to the antennas.

In one embodiment, the receiver arrangement provided includes a determining unit determining the distance from a communication device transmitting signals to the antennas to the antennas, comprising a first determining unit determining the power of the signals received from the communication device at the corresponding two receivers coupled to adjacent antennas, and a second determining unit determining the angle between the plane on which the adjacent antennas are arranged and the direction of the communication device with respect to the mid-point of the adjacent antennas on the said plane, when the sum of the power of the signals received from the communication device at the said corresponding two receivers is maximum.

In this embodiment, the distance from a communication device transmitting signals to the antennas, to the antennas may be determined if the following two parameters are known.

Firstly, the angle between the plane on which the adjacent antennas are arranged and the direction of the communication device with respect to the mid-point of the adjacent antennas on the said plane can be determined by beam steering until a point where the sum of the power of the signals received from the communication device at the said corresponding two receivers is maximum is detected. This is the first parameter used in order to determine the distance from a communication device transmitting signals to the antennas, to the antennas.

The second parameter used in order to determine the distance from a communication device transmitting signals to the antennas, to the antennas, is also found when the point where the sum of the power of the signals received from the communication device at the said corresponding two receivers is maximum is detected, namely, the power received at the said corresponding two receivers.

In one embodiment, the communication device is a Radio Frequency Identification (RFID) tag.

In one embodiment, the receiver reference signal generator includes a frequency synthesizer.

In an embodiment, the receiver reference signal generator is used to generate the high frequency receiver reference signal using the low frequency received reference signal. A component which may be used to perform this function is a frequency synthesizer, for example. Accordingly, the receiver reference signal generator comprises a frequency synthesizer.

Also, in one embodiment, the frequency synthesizer is a phase-locked loop (PLL) based frequency synthesizer. In another embodiment, the frequency synthesizer is a delay-locked loop (DLL) based frequency synthesizer.

In one embodiment, each receiver is a Radio Frequency Identification (RFID) interrogator device.

In one embodiment, the receiver arrangement provided by the invention further includes a baseband processing and communication unit. In another embodiment, the baseband processing and communication unit includes at least one digital controller for digitally controlling the digital synthesizer signal generator.

In another embodiment of the invention, a transmitter arrangement is provided, having a digital synthesizer signal generator. The digital synthesizer signal generator has an input receiving a reference clock signal, a plurality of outputs, each output providing a reference signal being derived from the reference clock signal, wherein the plurality of reference signals have substantially the same frequency and different phases. Furthermore, a plurality of transmitters is provided, each transmitter having a reference signal input receiving one reference signal of the plurality of reference signals, a transmitter reference signal generator generating a transmitter reference signal using the received reference signal, a transmitter data input receiving a transmit data signal, an upconverting circuit upconverting the transmit data signal using the transmitter reference signal, and an upconverted transmit data signal output. Further, a plurality of antennas is provided and coupled to the upconverted transmit data signal output of at least one transmitter of the plurality of transmitters.

Embodiments of the invention emerge from the dependent claims.

In one embodiment, the reference clock signal is a crystal clock signal.

In one embodiment, the digital synthesizer signal generator has at least one Direct Digital Synthesizer (DDS). In another embodiment, the digital synthesizer signal generator includes a programmable processor. In still another embodiment, the digital synthesizer signal generator includes a (programmable) microprocessor.

In one embodiment, the transmitter arrangement further includes a phase detector circuit to provide phase compensation information which is used to perform phase compensation for the transmitter reference signals.

In this embodiment, the use of a phase detector circuit allows phase compensation to be performed for the transmitter reference signals, thereby allowing precise control of the phase delay in the transmitter reference signals. This in turn allows fine control of the beam steering of the transmitter arrangement provided by the invention.

In one embodiment, the plurality of antennas is arranged in a manner such that the distance between any two adjacent antennas is substantially equal.

In one embodiment, the number of antennas is the same as the number of transmitters.

In one embodiment, the transmitter arrangement further includes a frequency compensation circuit to provide frequency compensation for the transmitter reference signals.

In one embodiment, the transmitter reference signal generator has a frequency synthesizer. In another embodiment, the frequency synthesizer is a phase-locked loop (PLL) based frequency synthesizer. In still another embodiment, the frequency synthesizer is a delay-locked loop (DLL) based frequency synthesizer.

In one embodiment, each transmitter is a Radio Frequency Identification (RFID) interrogator device.

In one embodiment, the transmitter arrangement further includes a baseband processing and communication unit. In another embodiment, the baseband processing and communication unit includes at least one digital controller for digitally controlling the digital synthesizer signal generator.

Illustratively, a digital synthesizer signal generator and a plurality of antennas are combined with a plurality of receivers to form a receiver arrangement with adaptive beam steering system to perform receive beam steering. In a similar manner, a digital synthesizer signal generator and a plurality of antennas may be combined with a plurality of transmitters to form a transmitter arrangement with adaptive beam steering system to perform transmit beam steering.

In an embodiment of the invention, a crystal clock signal, which has low phase noise, is provided to the digital synthesizer signal generator. This is done to ensure that very small phase delay values are obtained for the phase delayed clock signals which are used for beam steering. This in turn allows fine control of the beam steering to be performed.

Embodiments of the invention provide the following effect.

Besides adapting multiple antennas for beam steering without a considerable redesign effort is required at the baseband interface to the antennas, embodiments of the invention also allow fine control of the beam steering to be performed. This means that the radiation beam of the antenna can be steered accurately to a desired angle.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A receiver arrangement, comprising
a digital synthesizer signal generator, comprising
an input receiving a reference clock signal,
a plurality of outputs, each output providing a reference signal being derived from the reference clock signal, wherein the plurality of reference signals have substantially the same frequency and different phases, and
a plurality of receivers, each receiver comprising
a reference signal input receiving one reference signal of the plurality of reference signals,
a receiver reference signal generator generating a receiver reference signal using the received reference signal,
an antenna input receiving a transmission signal,
a downconverting circuit downconverting the received transmission signal using the receiver reference signal, and
a plurality of antennas coupled to the antenna input of at least one receiver of the plurality of receivers.

2. The receiver arrangement of claim 1, wherein the reference clock signal is a crystal clock signal.

3. The receiver arrangement of claim 1, wherein the digital synthesizer signal generator comprises at least one Direct Digital Synthesizer.

4. The receiver arrangement of claim 1, wherein the digital synthesizer signal generator comprises a programmable processor.

5. The receiver arrangement of claim 3, wherein the digital synthesizer signal generator comprises a microprocessor.

6. The receiver arrangement of claim 1, wherein the plurality of antennas is arranged in a manner such that the distance between each of adjacent antennas is substantially equal.

7. The receiver arrangement of claim 1, further comprising a communication device transmitting signals to the antennas.

8. The receiver arrangement of claim 7, further comprising a determining unit determining the distance from the communication device transmitting signals to the antennas, to the said antennas, comprising
a first determining unit determining the power of the signals received from the communication device at the corresponding two receivers coupled to adjacent antennas, and
a second determining unit determining the angle between the plane on which the said adjacent antennas are arranged and the direction of the communication device with respect to the mid-point of the said adjacent antennas on the said plane,
when the sum of the power of the signals received from the communication device at the said corresponding two receivers is maximum.

9. The receiver arrangement of claim 7, wherein the communication device is a Radio Frequency Identification tag.

10. The receiver arrangement of claim 1, wherein the receiver reference signal generator comprising
a frequency synthesizer.

11. The receiver arrangement of claim 10, wherein the frequency synthesizer is a phase-locked loop based frequency synthesizer.

12. The receiver arrangement of claim 10, wherein the frequency synthesizer is a delay-locked loop based frequency synthesizer.

13. The receiver arrangement of claim 1, wherein each receiver is a Radio Frequency Identification interrogator device.

14. The receiver arrangement of claim 1, further comprising
a baseband processing and communication unit.

15. The receiver arrangement of claim 14, wherein the baseband processing and communication unit comprises at least one digital controller for digitally controlling the digital synthesizer signal generator.

16. A transmitter arrangement, comprising
a digital synthesizer signal generator, comprising
an input receiving a reference clock signal,
a plurality of outputs, each output providing a reference signal being derived from the reference clock signal, wherein the plurality of reference signals have substantially the same frequency and different phases, and
a plurality of transmitters, each transmitter comprising
a reference signal input receiving one reference signal of the plurality of reference signals,
a transmitter reference signal generator generating a transmitter reference signal using the received reference signal,
a transmitter data input receiving a transmit data signal,
an upconverting circuit upconverting the transmit data signal using the transmitter reference signal,
an upconverted transmit data signal output, and
a plurality of antennas coupled to the upconverted transmit data signal output of at least one transmitter of the plurality of transmitters.

17. The transmitter arrangement of claim 16, wherein the reference clock signal is a crystal clock signal.

18. The transmitter arrangement of claim 16, wherein the digital synthesizer signal generator comprises at least one Direct Digital Synthesizer.

19. The receiver arrangement of claim 16, wherein the digital synthesizer signal generator comprises a programmable processor.

20. The receiver arrangement of claim 19, wherein the digital synthesizer signal generator comprises a microprocessor.

21. The transmitter arrangement of claim 16, further comprising
a phase detector circuit to provide phase compensation information which is used to perform phase compensation for the transmitter reference signals.

22. The transmitter arrangement of claim 16, wherein the plurality of antennas is arranged in a manner such that the distance between any two adjacent antennas is substantially equal.

23. The transmitter arrangement of claim 16, wherein the number of antennas is the same as the number of transmitters.

24. The transmitter arrangement of claim 16, further comprising
a frequency compensation circuit to provide frequency compensation for the transmitter reference signals.

25. The transmitter arrangement of claim 16, wherein the transmitter reference signal generator comprising
a frequency synthesizer.

26. The transmitter arrangement of claim 25, wherein the frequency synthesizer is a phase-locked loop based frequency synthesizer.

27. The transmitter arrangement of claim 25, wherein the frequency synthesizer is a delay-locked loop based frequency synthesizer.

28. The transmitter arrangement of claim 16, wherein each transmitter is a Radio Frequency Identification interrogator device.

29. The transmitter arrangement of claim 16, further comprising
a baseband processing and communication unit.

30. The transmitter arrangement of claim 29, wherein the baseband processing and communication unit comprises at least one digital controller for digitally controlling the digital synthesizer signal generator.
